(19) United States
(12) Patent Application Publication
(10) Pub. No.: US 2014/0159990 A1
(43) Pub. Date: Jun. 12, 2014

(54) ANTENNA MOUNTED ON A CIRCUIT BOARD

(71) Applicant: OPTICON SENSORS EUROPE B.V., Hoofddorp (NL)

(72) Inventor: Alexander Azhari, Spanga (SE)

(73) Assignee: OPTICON SENSORS EUROPE B.V., Hoofddorp (NL)

(21) Appl. No.: 13/711,190

(22) Filed: Dec. 11, 2012

(51) Int. Cl. H01Q 1/22; H01P 11/00

(52) U.S. Cl. CPC H01Q 1/22; H01P 11/00
USPC 343/878; 29/600; 29/601

(57) ABSTRACT

An electronic circuit that needs to transmit or receive radio waves achieves that goal by using an antenna. This disclosure teaches an antenna that can be mounted on an edge of a circuit board. This disclosure teaches antenna shapes that, when mounted on an edge of a circuit board, can advantageously make contact with circuits on both sides of the board. Some antenna shapes have protruding portions with springiness that facilitates affixing the antenna to the board and facilitates reliable electrical contacts with the circuits. The disclosure also teaches methods for mounting an antenna on an edge of a circuit board.

### FIELD OF THE INVENTION

moon The present invention relates to radio antennas in general, and, more particularly, to antennas mounted on circuit boards.

### BACKGROUND OF THE INVENTION

There is a desire to have wireless devices that are small and low-cost. Wireless communication in wireless devices is most commonly accomplished through radio waves that are transmitted and received by means of an antenna. Therefore, the antenna is an important component of most wireless devices, especially because its size is largely determined by the wavelength of the desired radio waves. With the continuing trend in wireless devices toward smaller and smaller size, designing the antenna has become a notoriously difficult task that, in practice, is accomplished with limited success in achieving effective antenna performance.

The effectiveness of an antenna depends on attributes such as, for example, and without limitation, the shape of the antenna, its placement relative to other components of the wireless device, and the method used for connecting it to the circuitry of the wireless device. These attributes affect the functionality of an antenna as a transducer for converting electrical signals into radio waves, or vice versa. Other attributes include, for example, and without limitation, mechanical sturdiness, ease and reliability of mechanical attachment, reliability of electrical connections, and ease of mounting and installation. These and other attributes might not directly affect the functionality of an antenna, but they, too, are important in that they affect the effectiveness and durability of an antenna in a practical application.

These and other antenna attributes affect not only the effectiveness and cost of the antenna per se, but also the performance level and the cost of manufacturing of the wireless device in which the antenna is used. Therefore, practical antenna designs usually represent a compromise between cost and performance, all while having to meet size constraints that can be severe in many cases.

In this disclosure, the word “antenna” has the meaning commonly used in the art to refer to a physical object that might comprise, in addition to elements required for its electromagnetic functionality, also elements required for its physical stability, mechanical support and electrical interconnectivity.

In this disclosure, words such as “conductor”, “semiconductor”, “conductive”, and “conductivity” refer to electrical conduction, even when it is not explicitly so stated; similarly, words such as “insulator” and “insulating” refer to electrical insulation, even when it is not explicitly so stated. Also, in this disclosure, words such as “connect”, “interconnect” and related and inflected forms refer to electrical connections or interconnections, unless explicitly indicated otherwise.

Electronic devices usually comprise electronic circuitry mounted on a substrate, collectively referred to as a “circuit board”. Circuit boards are typically made out of a flat sheet of insulating material on which the circuitry is assembled. The circuitry typically comprises electronic components of various types interconnected by means of conductive interconnections. A common type of circuit board is the so-called “printed circuit board” wherein the interconnections are realized by traces of copper deposited on the insulating material. The word “printed” in the name of such boards derives from the fact that the pattern of deposited copper is created through techniques that are sometimes viewed as similar to printing.

Modern printed-circuit boards frequently have multiple layers of traces alternating with layers of insulating material. The insulating material might be FR4, ceramic, plastic, or other materials having certain desired electrical properties. Electronic components are typically affixed to a surface of a printed-circuit board by soldering them to the copper traces. In many cases, electronic components are affixed on both major surfaces of a printed-circuit board.

The presence of multiple layers and of electronic components on both major surfaces of some printed-circuit boards means that such circuit boards are intrinsically three-dimensional objects with a complex internal structure of layers and interconnections. However, their essential character and appearance is as flat, relatively thin sheets, and that's why they are commonly referred to as “boards”. Because of this similarity to objects such as cardboard or sheets of paper, it is customary to refer to the major surfaces of a circuit board as “sides”; of course, there are two and only two such sides. It is also customary to use words such as “edges” or “perimeter”—to refer to the minor surfaces of a circuit board individually or collectively—with their commonly-understood meaning by analogy to objects such as cardboard or sheets of paper.

In printed-circuit boards, interconnection between electronic components on opposite sides is accomplished by drilling holes through the board and by inserting conductive material in the holes. Traces on both sides of the board are brought close to the holes, so that they make contact with the conductive material in the holes, thus establishing electrical connections between the two sides. Such holes can be referred to as “via holes”, or “through holes”. The term “via hole” is used generally to refer to holes that interconnect different layers. The term “through hole” is used, more specifically, for via holes that go across the entire thickness of the board. Through holes can accommodate a wire that can be the lead of a leaded electronic component. Through holes are frequently used where there is a need to achieve a firm mechanical anchor to the board for a leaded component requiring strong mechanical support. Printed-circuit boards, via holes, and through holes are well known to those skilled in the art.

Hereinafter, “circuit board” will be understood to refer not just to printed-circuit boards, but, more generally, to any circuit that comprises a sheet of material that supports circuitry, whether or not the material is electrically insulating. For example, integrated circuits are built on a flat sheet of semiconductor material, frequently referred to as a “wafer.” Even though the semiconductor material might not be a good insulator, there are techniques well known in the art for making traces and placing circuitry on the surface of such a wafer. Examples of a circuit board include, but are not limited to:
i. a printed-circuit board with a circuit on it, or
ii. a ceramic substrate with a circuit on it, or
iii. a semiconductor wafer with a circuit on it, or
iv. a semiconductor substrate with a circuit on it, or
v. an integrated circuit based on a piece of silicon wafer, or
vi. an integrated circuit based on any type of semiconductor wafer, or
vii. a flexible substrate with a circuit on it, or
viii. any circuit comprising a flat sheet of material for supporting the circuitry.
   Also, hereinafter, the word “trace” will be understood to refer to any type of electrical interconnection on a circuit board, whether or not made of copper or printed on the surface or on an internal layer of the circuit board.

Circuits for radio transmitters or receivers need antennas for converting electric signals into radio waves or vice versa. When a circuit is in the form of a circuit board, several options are available. For example, and without limitation, a connector might be mounted on the circuit board, and an antenna might be connected to the circuit board via the connector. Such a solution is undesirable in many circumstances because it incurs the added cost of the connector and, possibly, a cable; also, the antenna or cable need to have a mating connector. Alternatively, an antenna might be mounted directly on the circuit board.

Several types of antennas are known in the art that are suitable for mounting directly on a circuit board. Many such antennas are just a piece of metal with a precisely-defined shape. There is a large body of knowledge regarding how to define the shape of a piece of metal that will make the piece of metal an effective antenna in a given situation, and there are several methods for mounting such an antenna on a circuit board that achieve a rigid mechanical structure and an effective electrical connection of the antenna to the circuitry.

FIG. 1 depicts an antenna in the prior art mounted on the surface of a circuit board. Antenna 120 is a depiction of a type of antenna known in the art as an “inverted-F” antenna. Such an antenna might be advantageously made out of a piece of sheet metal that is stamped to have a desired flat shape and then bent to have a desired three-dimensional shape, as depicted in FIG. 1. Antenna 120 is affixed to circuit board 110 using rivets 130-1 and 130-2 as depicted in FIG. 1. The use of rivets for affixing an antenna to a printed-circuit board is well-known in the art, and is advantageous in that it provides a solid mechanical attachment between the antenna and the circuit board. Rivets are also capable of providing an electrical connection between the antenna and circuitry on the circuit board, in well-known fashion.

FIG. 2 depicts another inverted-F antenna in the prior art mounted on the surface of a circuit board. In FIG. 2, antenna 220 is affixed to circuit board 210 using solder joints 230-1 and 230-2 as depicted in FIG. 2. The use of solder joints for affixing an antenna to a printed-circuit board is well-known in the art, and is advantageous in that, although solder joints are not as sturdy as rivets, it can be accomplished without requiring space on the side of the circuit board opposite the side where the antenna is mounted. Solder joint are also advantageous in that they provide a reliable electrical connection.

FIG. 3 depicts another inverted-F antenna in the prior art and a method of mounting it on the surface of a circuit board. In FIG. 3, antenna 320 is made out of a piece of metal stamped and shaped so as to have three pins to be inserted into three through holes. Antenna 320 is affixed to circuit board 310 by inserting the three pins 340-1, 340-2, and 340-3 into through holes 330-1, 330-2, and 330-3. The three pins are sized and positioned such that they can fit into the three through holes. The dashed lines in FIG. 3 show how the three pins can be inserted into the three through holes. After insertion, the pins can be attached to the through holes by means of solder joints, not shown in FIG. 3. The use of pins in through holes for affixing an antenna to a printed-circuit board is well-known in the art and is advantageous in that it provides both a solid mechanical attachment, between the antenna and the circuit board, and a reliable electrical connection between the antenna and circuitry that might be on either side of the board.

The prior-art methods of mounting an antenna on a circuit board depicted in FIGS. 1, 2, and 3, as well as other prior-art methods of mounting an antenna on a circuit board, suffer from several disadvantages. For example, FIGS. 1, 2, and 3 clearly show that there is an area of the circuit board that must be reserved for affixing the antenna and that, therefore, is not available for circuitry. Also, prior-art methods of mounting an antenna on a circuit board require installation steps that might be labor intensive or costly, or both.

### SUMMARY OF THE INVENTION

Embodiments of the present invention are based on an antenna that is mounted on an edge of a circuit board. By mounting an antenna on an edge of a circuit board, instead of on one of the major surfaces of a circuit board, some of the disadvantages of prior-art methods of antenna mounting are obviated. Antennas in accordance with the present invention are made to have a shape that, in addition to being effective for achieving good antenna performance, is well suited for mounting on an edge of a circuit board. In particular, antennas in accordance with the present invention have protruding portions designed to extend over both sides of the circuit board in a boardward direction. Such protruding portions can be advantageously used for electrically connecting the antenna to circuitry on both sides of the circuit board, or for mechanically affixing the antenna to the circuit board, or for both purposes.

In alternative embodiments of the present invention, the protruding portions are made so as to have the property of “springiness”. Springiness is defined in the American Heritage Dictionary, third edition, as the property of being marked by resilience; being elastic. Accordingly, in this disclosure, the word “springiness” is used in reference to objects that tend to return to their original shape after deformation. Such tendency manifests itself as a restoring force that pushes an object toward its original shape. A desired amount of springiness and a desired direction of the restoring force can be obtained, in well-known fashion, by appropriately choosing the shape of the object and the material of which the object is made.

When one or more of the protruding portions have springiness, an antenna in accordance with the present invention can be mounted on an edge of a circuit board such that the springiness causes pressure to be applied to the board by some or all of the protruding portions. Such pressure can be made sufficiently strong to keep the antenna firmly affixed to the circuit board, thus providing a solid mechanical attachment between the antenna and the circuit board.

In alternative embodiments of the present invention, some or all of the protruding portions that apply pressure to the board are positioned such that the pressure is applied to conductive traces on the board. The pressure can be made of sufficient strength to cause those protruding portions to establish a reliable electrical contact with the traces. Such contacts provide the desired electrical connection between the antenna and the circuitry on the board.

In alternative embodiments of the present invention, the reliability of the electrical contact between a protruding portion that applies pressure and a conductive trace is improved or facilitated by placing a bump or other protuberance on the protruding portion that applies pressure. Such bump or protuberance can be positioned to be at the point of electrical contact. In alternative embodiments, the protuberance can have a sharp edge or a barb that further facilitates the reliability of the electrical contact.

In alternative embodiments of the present invention, there is a notch in the circuit board, and the antenna is shaped such that some part of it fits in the notch. The notch facilitates correct mounting of the antenna in the correct position. The same objective is achieved in other embodiments of the present invention by having a prong in the circuit board that fits into a mating part of the antenna designed to accommodate the prong.

Other embodiments of the present invention comprise a method for mounting the antenna on an edge of the circuit board by sliding or snapping the antenna on the edge of the circuit board such that the springiness of one of the protruding portions is activated and, thereafter, holds the antenna affixed to the board, possibly with a reliable electrical contact, in embodiments where that is desired.

### BRIEF DESCRIPTION OF THE DRAWINGS

FIG. 1 depicts an antenna mounted on a circuit board with rivets, in the prior art.

FIG. 2 depicts an antenna mounted on a circuit board with solder joints, in the prior art.

FIG. 3 depicts an antenna mounted on a circuit board with through holes, in the prior art.

FIG. 4 depicts an antenna for mounting on an edge of a circuit board, in accordance with an embodiment of the present invention.

FIG. 5a depicts an antenna mounted on an edge of a circuit board, in accordance with an embodiment of the present invention, in perspective view.

FIG. 5b depicts an antenna mounted on an edge of a circuit board, in accordance with an embodiment of the present invention, in edge view.

FIG. 6a depicts an antenna with a spring-loaded tab for mounting on an edge of a circuit board, in accordance with an embodiment of the present invention. The antenna is depicted mounted on an edge of a circuit board. The figure depicts a perspective view.

FIG. 6b depicts an antenna with a spring-loaded tab for mounting on an edge of a circuit board, in accordance with an embodiment of the present invention. The antenna is depicted mounted on an edge of a circuit board, in accordance with an embodiment of the present invention. The figure depicts an edge view.

FIG. 7 depicts an antenna with spring-loaded tabs with protuberances for mounting on an edge of a circuit board, in accordance with an embodiment of the present invention. The protuberances are shown as bumps making electrical contacts with copper traces. The antenna is depicted mounted on an edge of a circuit board. The figure depicts an edge view.

FIG. 8 depicts an antenna with spring-loaded tabs with protuberances for mounting on an edge of a circuit board, in accordance with an embodiment of the present invention. The protuberances are shown as comprising sharp edges making electrical contacts with copper traces. The antenna is depicted mounted on an edge of a circuit board. The figure depicts an edge view.

FIG. 9 depicts an antenna mounted in a notch on an edge of a circuit board, in accordance with an embodiment of the present invention. The figure depicts a perspective view.

FIG. 10 depicts a method of mounting an antenna on an edge of a circuit board, in accordance with an embodiment of the present invention. The figure depicts a perspective view.

FIG. 11 depicts a method of mounting an antenna on an edge of a circuit board, in accordance with an embodiment of the present invention. The figure depicts a perspective view.

FIG. 12 depicts a method of mounting an antenna on an edge of a circuit board, in accordance with an embodiment of the present invention. The figure depicts an edge view.

FIG. 13 depicts a method of mounting an antenna on an edge of a circuit board, in accordance with an embodiment of the present invention. The figure depicts an edge view.

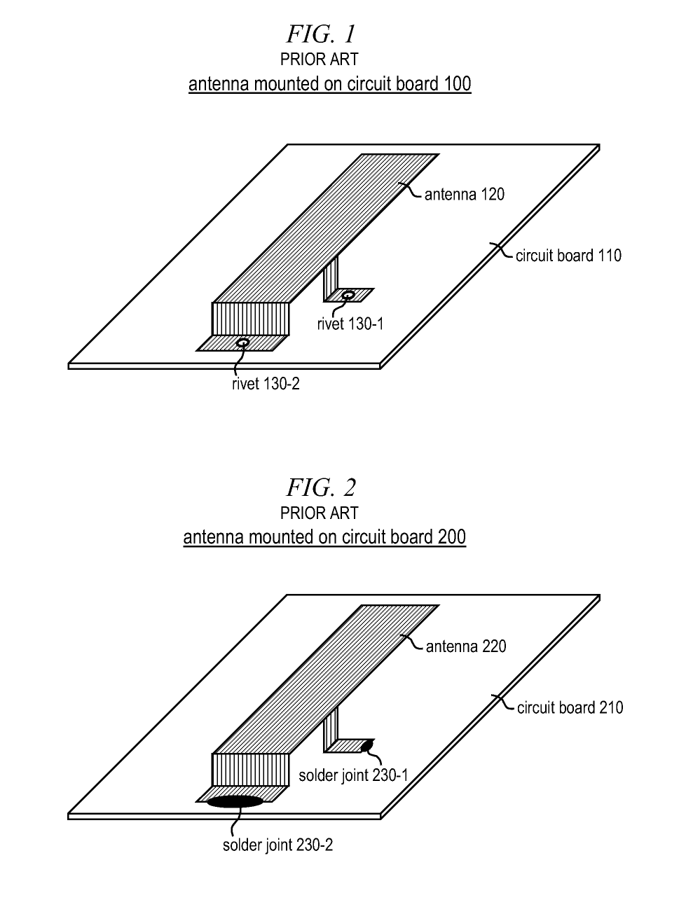

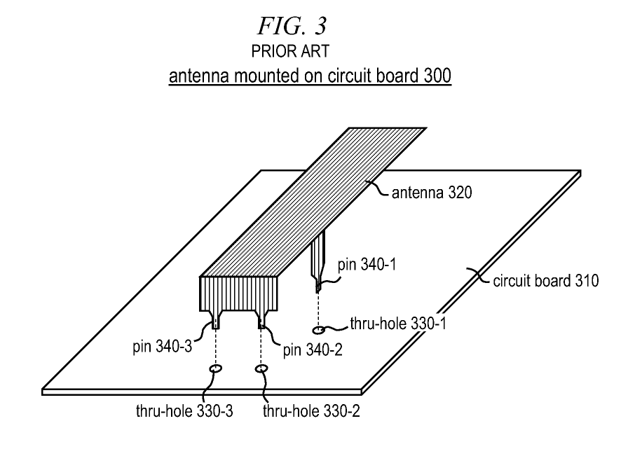

### DETAILED DESCRIPTION

This disclosure uses words such as “up”, “down”, “over”, “under”, “top”, “bottom”, “above”, “below” and other such words that, commonly, identify a position or direction in a gravity field. For example, a side of a circuit board depicted in a figure might be identified as the “bottom side”. Such words are used because they make it easier to explain and visualize geometric structures. In particular, objects depicted in figures appear to the observer as having a well-defined orientation relative to gravity, so that identifying a side of a circuit board in a figure as the “bottom side” is an unambiguous identification as it refers to the side of the board that appears to be lower, as depicted. These words are not intended to convey any association with the force of gravity. The present invention does not rely on gravity or on any definitions of such words relative to a gravity field. Embodiments of the present invention operate as intended regardless of the orientation of the embodiments in a gravity field, and regardless of whether or not there is a gravity field to give an absolute meaning to “up”, “down”, etc.

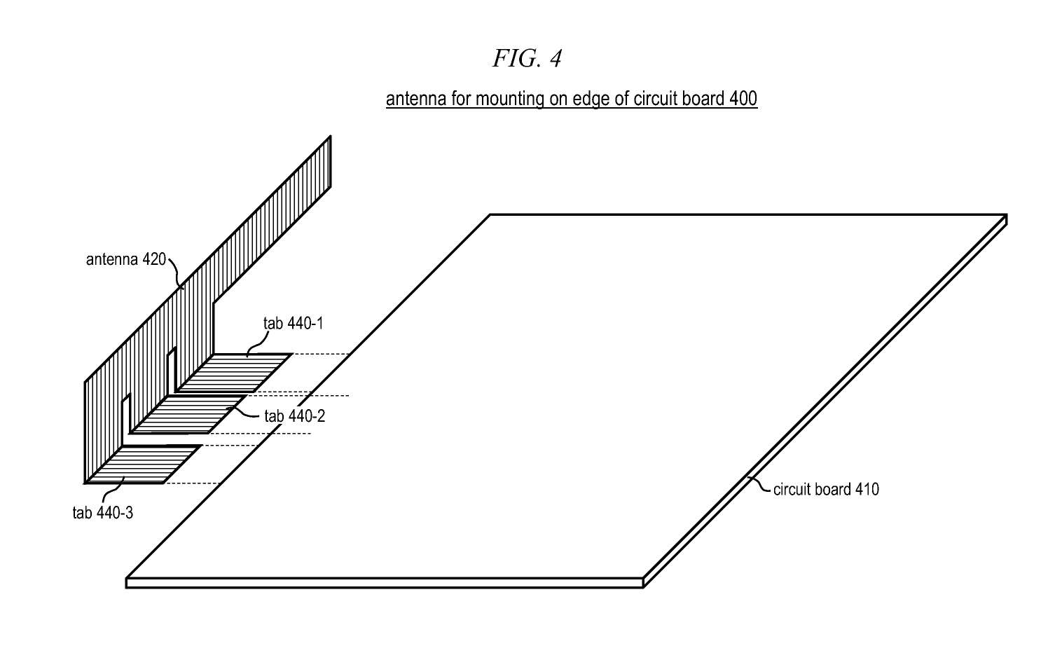

FIG. 4 depicts an antenna for mounting on an edge of a circuit board in accordance with an illustrative embodiment of the present invention. The circuit board is depicted by circuit board 410. The antenna is depicted by antenna 420, which is a piece of metal shaped so as to be an effective antenna when mounted on the edge of the circuit board. It is well-known in the art how to shape a piece of metal so as to be an effective antenna. Antenna 420 is also shaped so as to have three protruding portions, depicted in FIG. 4 by tabs 440-1, 440-2, and 440-3.

The three protruding portions are designed such that, when the antenna is mounted on the edge of the circuit board, they protrude away from the edge of the circuit board in a boardward direction. Some of the protruding portions are designed to be over one side of the circuit board, and some others of the protruding portions are designed to be over the other side of the circuit board. In particular, the dashed lines in FIG. 4 show how tabs 440-1 and 440-3 are designed to go over the bottom side of circuit board 410, and how tab 440-2 is designed to go over the top side of circuit board 410.

In this disclosure, the expression “in a boardward direction” is used to refer to the orientation of a protruding portion of the antenna when mounted on the circuit board. In particular, in the context of the illustrative embodiments, the boardward direction means extending from the edge of a circuit board toward the inside of the perimeter of the board; thus, a protruding portion that protrudes in a boardward direction is one that lies over one side of the circuit board. In this context, the word “over” is used to indicate that the protruding portion is in the volume of space that is inside a projection of the board's perimeter extended perpendicularly to the plane of the board in the direction of that one side of the board. For consistency, the word “over” is used even referred to a side of a board that might be identified as “bottom side” in a figure, as opposed to using the word “under” in such cases.

In the case of flexible circuit boards, which are well-known in the art, “perpendicularly to the plane” means perpendicularly to the plane that is tangent to the curved surface of a flexible board at the point where the antenna is mounted.

The depiction of circuit board 410 in FIG. 4 does not show explicitly any circuitry or traces. Such items are not depicted because they are not necessary for those skilled in the art to understand the features of the present invention that FIG. 4 is intended to depict. Hereinafter, the drawings that are part of this disclosure will not explicitly depict traces or other items commonly present on circuit boards unless needed to make the depiction clear to those skilled in the art. It will be clear to those skilled in the art, after reading this disclosure, how to make and use embodiments of the present invention that comprise circuit boards with circuitry, traces, and other items; such items might include traces or other conductive elements arranged so as to make one or more electrical contacts with antenna 420, or with other antennas, as needed to achieve a desired functionality.

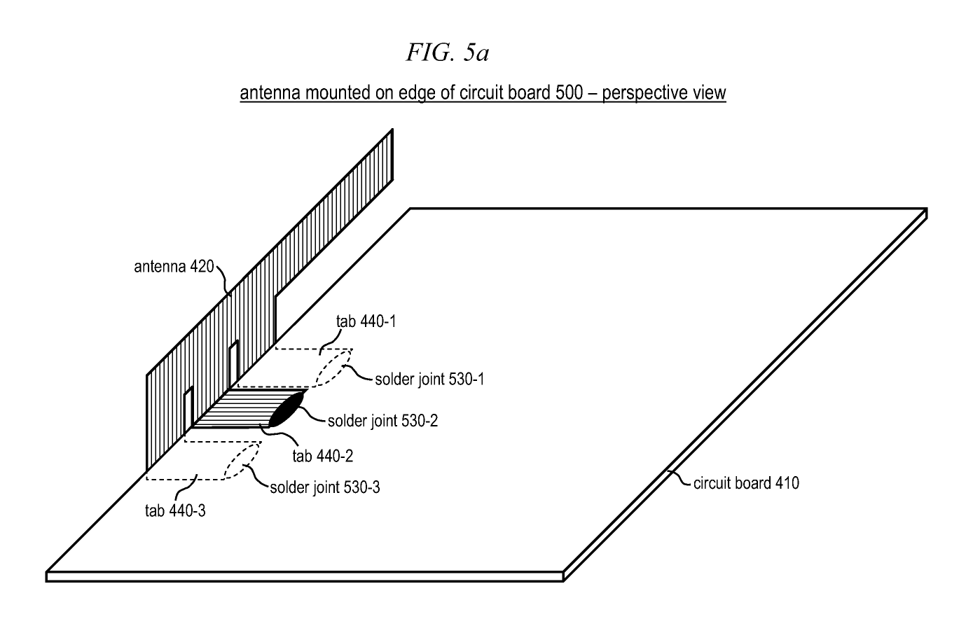

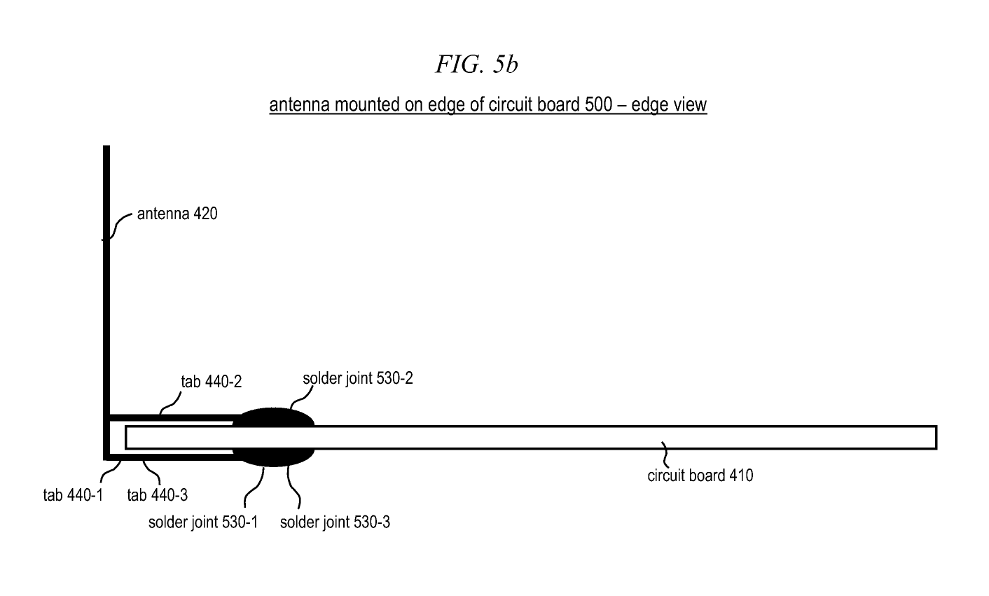

FIG. 5a depicts antenna 420 as mounted on the edge of circuit board 410. Tab 440-2 is visible as protruding in a boardward direction from the edge of circuit board 410 over the top side of the circuit board. Tabs 440-1 and 440-3 are not visible because they protrude in a boardward direction from the edge of circuit board 410 over the bottom side, which is the side not visible in FIG. 5a; accordingly, they are shown only as dashed outlines. The Figure also depicts how antenna 420 can be affixed to circuit board 410 by means of solder joints 530-1, 530-2, and 530-3. Solder joints 530-1 and 530-3 are not visible because they are on the bottom side of circuit board 410, which is the side not visible in FIG. 5a; accordingly, they are shown only as dashed outlines. It will be clear to hose skilled in the art, after reading this disclosure, how to make and use embodiments of the present invention wherein solder joints 530-1, 530-2, and 530-3 are attached to traces or other conductive elements so that, in addition to providing a solid mechanical attachment between the antenna and the circuit board, they might also provide electrical connections between the antenna and circuitry on the circuit board.

FIG. 5b is an alternative depiction of antenna 420 as mounted on the edge of circuit board 410. In particular, FIG. 5b depicts an edge view which shows parts not visible in FIG. 5a, which, like FIG. 4, depicts a perspective view. Circuit board 410 is depicted by a thin rectangle, which represents the circuit board viewed edge-on. Antenna 420 is depicted by thin lines to reflect the fact that, in this illustrative embodiment, the antenna is made out of a piece of thin sheet metal which, when viewed edge-on, appears as a thin line. In this edge view, the tabs protruding in a boardward direction over the bottom side, i.e., tabs 440-1, and 440-3, are visible; and the tab protruding in a boardward direction over the top side, i.e., tab 440-2, which was visible in FIG. 5a, is also visible. The Figure also depicts solder joint 530-2 on the top side, and solder joints 530-1 and 530-3 on the bottom side. In this edge view, a single black line depicts both tabs 440-1 and 440-3, and a single black blob depicts both solder joints 530-1 and 530-3, as expected for an edge view.

Although FIGS. 4, 5a, and 5b depict an antenna with a specific shape, it will be clear to those skilled in the art, after reading this disclosure, how to make and use embodiments of the present invention wherein the antenna has a different shape. The particular shape of an antenna for a particular application is affected by parameters such as the frequencies of the radio signals to be handled by the antenna, their bandwidth, the electrical characteristics of the circuitry, the desired antenna radiation pattern to be achieved, the mode of use of the finished product, and the type and material of the housing of the finished product, just to name a few. It will be clear to those skilled in the art, after reading this disclosure, how to devise a shape for the antenna that achieves the desired antenna behavior.

Although FIGS. 4, 5a, and 5b depict an antenna made out of sheet metal, it will be clear to those skilled in the art, after reading this disclosure, how to make and use embodiments of the present invention wherein the antenna is made out of a different conductive material. The expression “conductive material” is used in this disclosure to indicate any material or combination of materials having intrinsic conductivity, or artificially processed to endow the material or combination with conductivity sufficient for performing the desired function. For example, and without limitation, conductive materials suitable for making the antenna, comprise, but are not limited to:
i. sheet metal, or
ii. machined metal or alloys, or
iii. cast metal or alloys, or
iv. conductive plastic, or
v. conductive ceramic, or
vi. semiconductor material, or
vii. non-conductive material such as, for example, plastic that is entirely or partially coated with one or more conductive layers, or
viii. non-conductive material with conductive material embedded in it,
ix. a combination of i, ii, iii, iv, v, vi, vii, or viii.
   Also, it will be clear to those skilled in the art, after reading this disclosure, how to make and use embodiments of the present invention wherein the antenna comprises different parts made of different materials wherein not necessarily all parts are made of conductive material. For example, and without limitation, an antenna might comprise parts made of non-conductive plastic that provide mechanical support for parts made of metal.

Although FIGS. 4, 5a, and 5b depict an antenna with three protruding portions in the shape of tabs, with the two end tabs over the bottom side of the circuit board and the center tab over the top side of the circuit board, it will be clear to those skilled in the art, after reading this disclosure, how to make and use embodiments of the present invention wherein the antenna has a different number of protruding portions of different shapes, and with different numbers of protruding portions over the two sides of the board.

Although FIGS. 4, 5a, and 5b depict an antenna affixed to the circuit board by means of solder joints on all protruding portions, it will be clear to those skilled in the art, after reading this disclosure, how to make and use embodiments of the present invention wherein the antenna is affixed to the circuit board differently. For example, and without limitation, the antenna might be affixed through:
i. soldering, or
ii. riveting, or
iii. brazing, or
iv. welding, or
v. gluing, or
vi. bonding, or
vii. prongs in through holes, or
viii. any other method suitable for affixing, or
ix. a combination of i, ii, iii, iv, v, vi, vii or viii.

It will also be clear to those skilled in the art, after reading this disclosure, how to make and use embodiments of the present invention wherein fewer than all protruding portions have solder joints or other attachments to the circuit board, and wherein one or more attachments provide reliable electrical contacts with one or more traces or components on the circuit board.

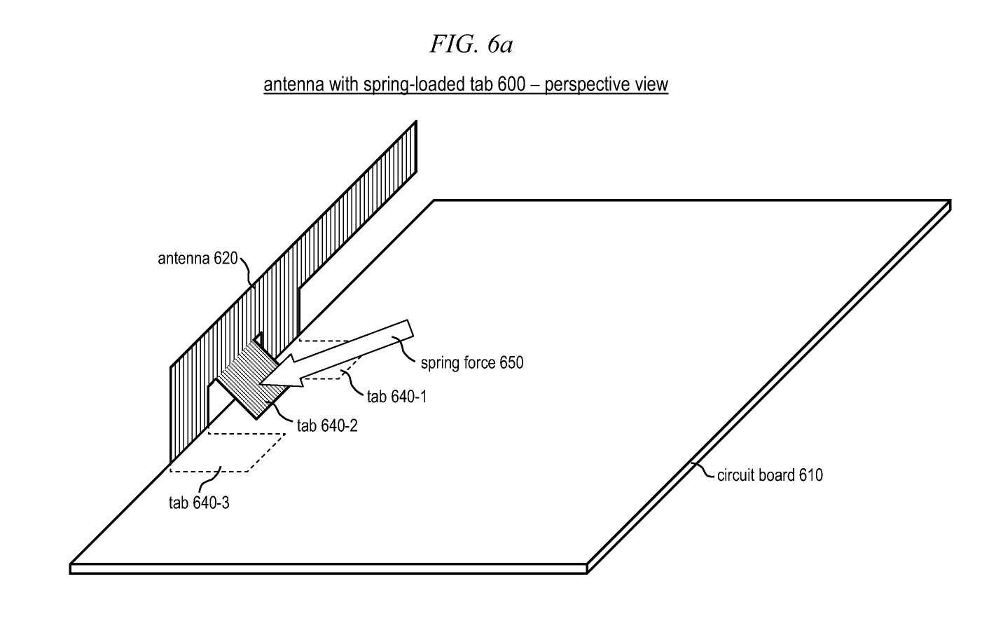

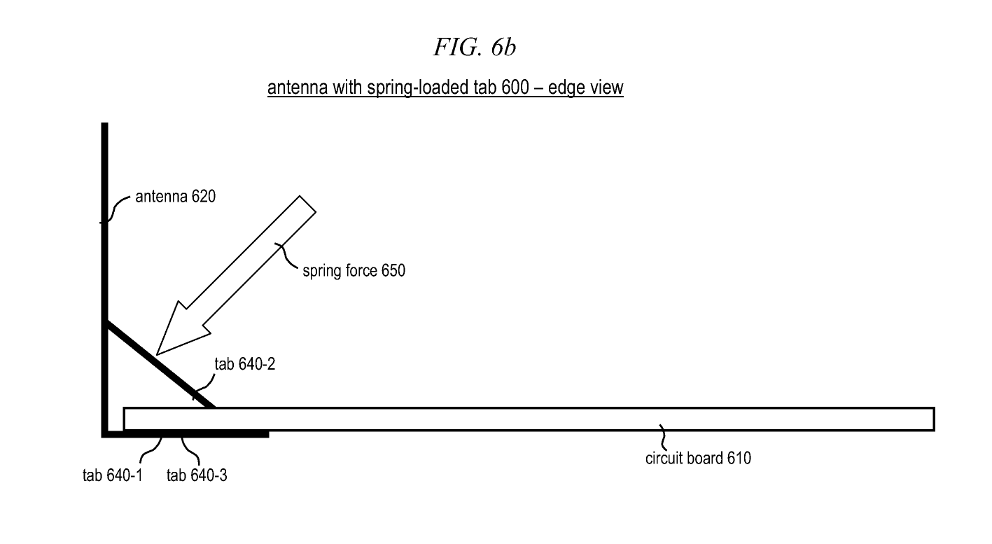

FIG. 6a depicts an antenna for mounting on an edge of a circuit board in accordance with an alternative illustrative embodiment of the present invention. The circuit board is depicted by circuit board 610. The antenna is depicted by antenna 620, which is a piece of sheet metal shaped to have a protruding portion, depicted by tab 640-2 in FIG. 6a, which has the property of springiness. Antenna 620 has two additional protruding portions depicted by tabs 640-1 and 640-3 that protrude over the bottom side of circuit board 610; because they protrude over the bottom side, they are not visible in FIG. 6a and, accordingly they are shown as dashed outlines. Antenna 620 is depicted as mounted on the edge of circuit board 610.

Springiness is defined in the Summary section of this disclosure as the property that makes springs and other similar objects work. Because of springiness, tab 640-2 applies pressure to circuit board 610 with a force whose direction is depicted in FIG. 6a by an arrow labeled “spring force 650”. The direction of spring force 650 and the shape of antenna 620 are such that spring force 650 holds antenna 620 firmly affixed to circuit board 610.

FIG. 6b is an alternative depiction of antenna 620 as mounted on the edge of circuit board 610. In particular, FIG. 6b depicts an edge view which shows parts not visible in FIG. 6a. Circuit board 610 is depicted by a thin rectangle, which represents the circuit board viewed edge-on. Antenna 620 is depicted by thin lines to reflect the fact that, in this illustrative embodiment, the antenna is made out of a piece of thin sheet metal which, when viewed edge-on, appears as a thin line. In this edge view, the two tabs protruding in a boardward direction over the bottom side, i.e., tabs 640-1, and 640-3, are visible; and the tab protruding in a boardward direction over the top side, i.e., tab 640-2, which was visible in FIG. 6a, is also visible. In this edge view, a single black line depicts both tabs 640-1 and 640-3, as expected for an edge view. The Figure also depicts how antenna 620 can be firmly affixed to circuit board 610 without requiring solder joints or other attachments by virtue of the pressure applied by spring force 650, which is depicted by an arrow.

Although FIGS. 6a, and 6b depict an antenna with a specific shape, made out of sheet metal, and with three protruding portions, it will be clear to those skilled in the art, after reading this disclosure, how to make and use embodiments of the present invention wherein the antenna is made differently. The comments that were made for FIGS. 4, 5a, and 5b also apply for FIGS. 6a and 6b. It will be clear to those skilled in the art, after reading this disclosure, that the materials listed in paragraph [0049] might be made to have springiness as needed for antenna 620.

FIGS. 6a and 6b do not depict solder joints for affixing antenna 620 to circuit board 610 because the springiness of tab 640-2 is sufficient for keeping antenna 620 firmly affixed to circuit board 610. However, it will be clear to those skilled in the art, after reading this disclosure, how to make and use embodiments of the present invention wherein the antenna also has one or more protruding portions that are soldered or otherwise attached to the circuit board, whether or not they have springiness. For example, and without limitation, a solder joint might be used on a protruding portion while the springiness of the same or another protruding portion maintains the antenna firmly affixed to the circuit board either permanently or for the purpose of holding the antenna stable for soldering.

Although FIGS. 6a, and 6b depict only tab 640-2 as having springiness and applying pressure to circuit board 610, it will be clear to those skilled in the art, after reading this disclosure, how to make and use embodiments of the present invention wherein the antenna has one or more protruding portions that have springiness and apply pressure, and has one or more protruding portions which, while not having springiness, nonetheless apply pressure to circuit board 610 due the springiness of the protruding portions that have springiness. Indeed, in FIGS. 6a and 6b, it will be clear to those skilled in the art, after reading this disclosure, that tabs 640-1 and 640-3 apply upward pressure to circuit board 610, even though it is not explicitly shown in the figures. Such pressure exists because tabs 640-1 and 640-3 oppose the pressure applied by tab 640-2, such that circuit board 610 is squeezed between tab 640-2 on one side, and tabs 640-1 and 640-3 on the other side.

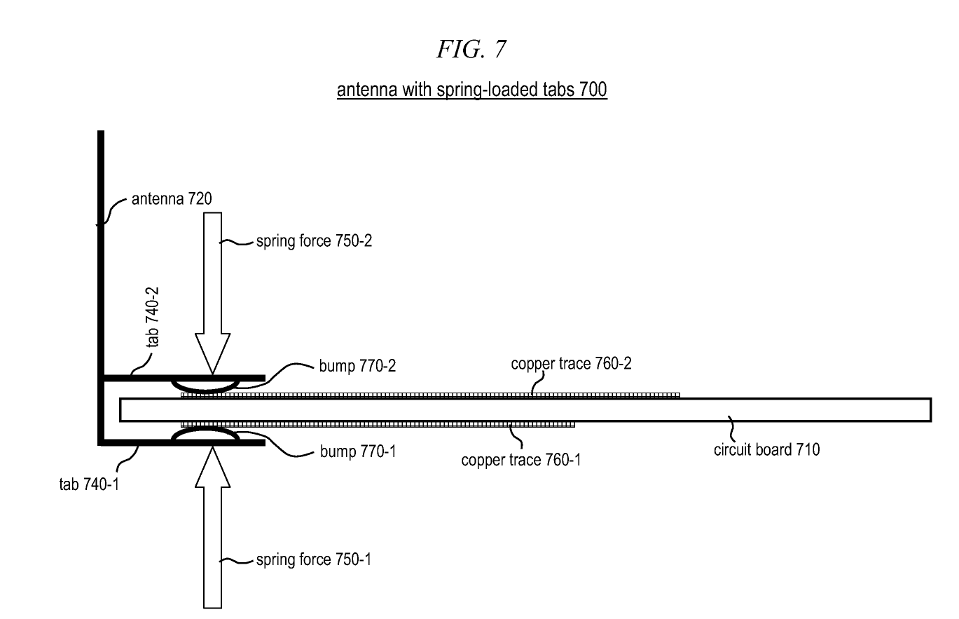

FIG. 7 depicts an antenna for mounting on an edge of a circuit board in accordance with an alternative illustrative embodiment of the present invention. The circuit board is depicted by circuit board 710. The antenna is depicted by antenna 720, which is a piece of sheet metal shaped to have protruding portions, two of which are depicted by tabs 740-1 and 740-2 in FIG. 7. The Figure depicts an edge view. Antenna 720 is depicted as mounted on the edge of circuit board 710. One or more protruding portions have springiness, such that tabs 740-1 and 740-2 both apply pressure to circuit board 710 such that circuit board 710 is squeezed between the two tabs. In FIG. 7, spring force 750-1 and spring force 750-2 depict the directions of the pressure applied by tabs 740-1 and 740-2, respectively.

In FIG. 7, two copper traces on circuit board 710 are depicted explicitly as copper traces 760-1 and 760-2; they are positioned such that the pressure applied to circuit board 710 by tabs 740-1 and 740-2 is applied through copper traces 760-1 and 760-2. The two copper traces are parts of circuit board 710 that come in direct contact with tabs 740-1 and 740-2.

The two tabs are shaped to have bumps, which are depicted in FIG. 7 as bumps 770-1 and 770-2. If antenna 720 is made out of sheet metal, the two bumps can be formed on the two tabs as part of the process of bending and shaping the sheet metal as is well known in the art. The bumps are the parts of the tabs that make direct contact with the traces.

The pressure applied by the tabs to the copper traces causes the metal of each tab to make an electrical contact with the trace that it touches. This would occur even in the absence of bumps 770-1 and 770-2, and materials are known in the art which enable the establishment of reliable electrical contacts without bumps if the applied pressure is of sufficient strength; but the two bumps enhance the quality of the contacts, thereby facilitating the establishment of reliable electrical contacts.

Although FIG. 7 depicts an antenna with a specific shape, made out of sheet metal, and with two protruding portions, it will be clear to those skilled in the art, after reading this disclosure, how to make and use embodiments of the present invention wherein the antenna is made differently. The comments that were made for FIGS. 4, 5a, and 5b also apply for FIG. 7. It will be clear to those skilled in the art, after reading this disclosure, that the materials listed in paragraph [0049] might be made to have springiness as needed for antenna 720, and might be shaped to have bumps equivalent to bumps 770-1 and 770-2.

Although the protruding portions of antenna 720 are depicted as tabs with bumps 770-1 and 770-2, wherein the bumps are protuberances that facilitate reliable electrical contacts, other protuberances having shapes other than bumps can be advantageously used to facilitate reliable electrical contacts. It will be clear to those skilled in the art, after reading this disclosure, how to make and use embodiments of the present invention wherein the antenna has a different number of protruding portions of different shapes, and wherein one or more of the protruding portions have protuberances other than bumps for facilitating reliable electrical contacts between one or more of the protruding portions and one or more traces on the circuit board.

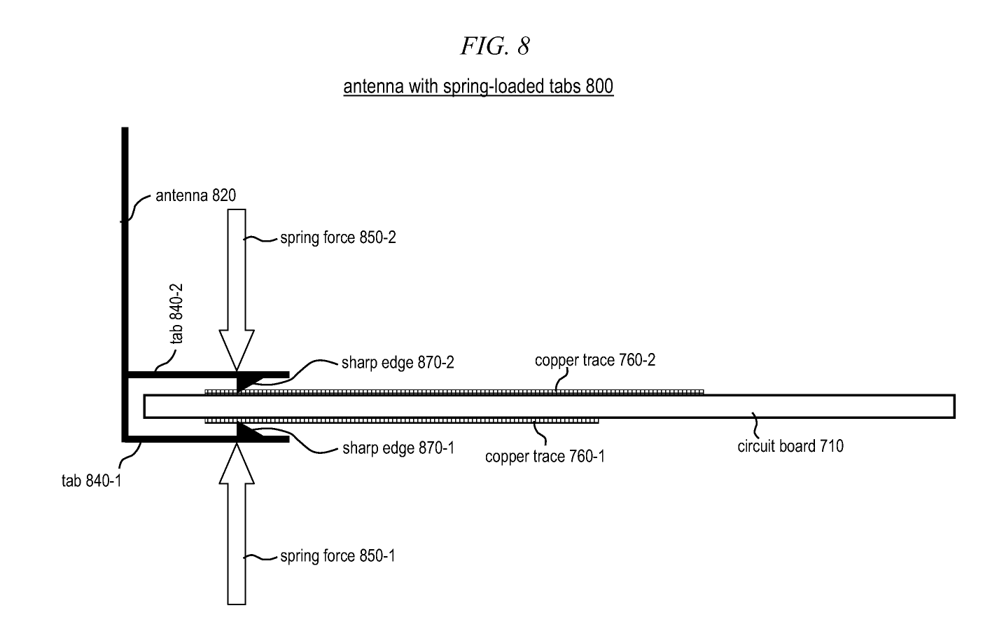

FIG. 8 depicts an antenna for mounting on an edge of a circuit board in accordance with an alternative illustrative embodiment of the present invention. The circuit board is depicted by circuit board 710. The antenna is depicted by antenna 820, which is a piece of sheet metal shaped to have protruding portions, two of which are depicted by tabs 840-1 and 840-2 in FIG. 8. The Figure depicts an edge view. Antenna 820 is depicted as mounted on the edge of circuit board 710. One or more protruding portions have springiness, such that tabs 840-1 and 840-2 both apply pressure to circuit board 710 such that circuit board 710 is squeezed between the two tabs. In FIG. 8, spring force 850-1 and spring force 850-2 depict the directions of the pressure applied by tabs 840-1 and 840-2, respectively.

In FIG. 8, the two copper traces 760-1 and 760-2 are positioned such that the pressure applied to circuit board 710 by tabs 840-1 and 840-2 is applied through the copper traces, similarly to FIG. 7. The salient difference between FIG. 8 and FIG. 7 is that the tabs of antenna 820 have protuberances that are not bumps; instead, the protuberances of the tabs of antenna 820 are depicted in FIG. 8 as comprising sharp edges 870-1 and 870-2. In the figure, the sharp edges are depicted in the shape of barbs. The sharp edges achieve two objectives: i) they provide a firmer mechanical attachment for affixing the antenna to the circuit board; and ii) they further facilitate reliable electrical contacts between the protuberances and the traces.

Although FIG. 8 depicts an antenna with a specific shape, made out of sheet metal, and with two protruding portions, it will be clear to those skilled in the art, after reading this disclosure, how to make and use embodiments of the present invention wherein the antenna is made differently. The comments that were made for FIGS. 4, 5a, and 5b also apply for FIG. 8. It will be clear to those skilled in the art, after reading this disclosure, that the materials listed in paragraph [0049] might be made to have springiness as needed for antenna 820 and might be shaped to have sharp edges equivalent to have sharp edges 870-1 and 870-2.

Although FIG. 8 depicts an antenna with two protruding portions, each with a protuberance, each protuberance comprising a sharp edge depicted by a triangular shape or barb, it will be clear to those skilled in the art, after reading this disclosure, how to make and use embodiments of the present invention with any number of protruding portions, with or without protuberances, with any number of protuberances comprising one or more sharp edges of any of a variety of shapes known in the art for making a sharp edge.

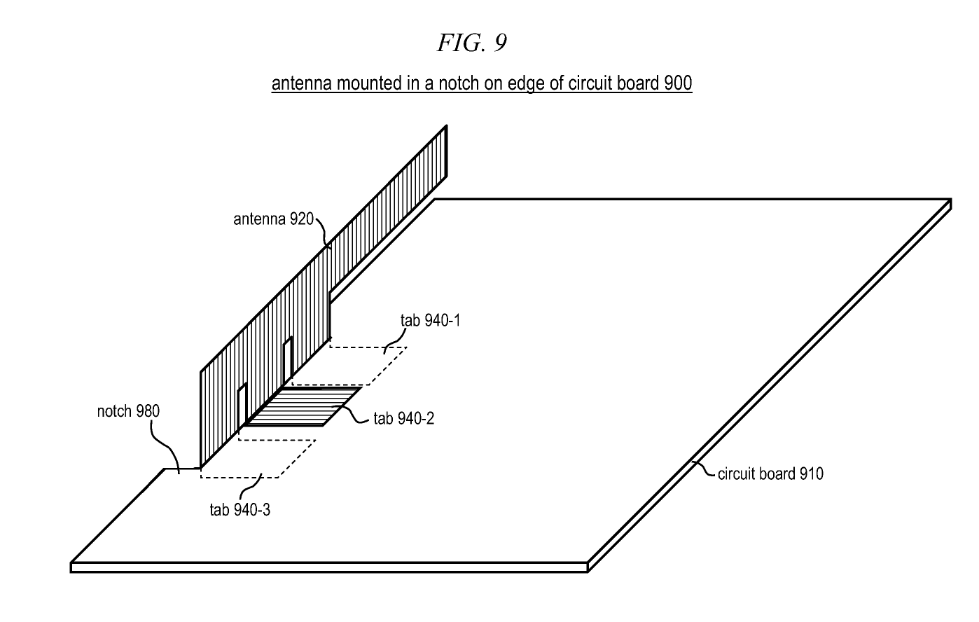

FIG. 9 depicts an antenna for mounting on an edge of a circuit board in accordance with an alternative illustrative embodiment of the present invention. The circuit board is depicted by circuit board 910. The antenna is depicted by antenna 920, which is a piece of sheet metal shaped to have protruding portions, one of which is visible in FIG. 9 and is depicted by tab 940-2. The Figure depicts a perspective view. Antenna 920 has two additional protruding portions, depicted by tabs 940-1 and 940-3, which protrude over the bottom side of circuit board 910; because they protrude over the bottom side, they are not visible in FIG. 9 and, accordingly, they are shown as dashed outlines. Antenna 920 is depicted as mounted on an edge of circuit board 910 in a notch, depicted by notch 980.

Notch 980 is a portion of the edge of circuit board 910 where some of the circuit-board material has been removed, compared to a straight edge. In particular, FIG. 9 depicts notch 980 as a rectangular indentation in the edge of the circuit board. The indentation is long enough to accommodate the part of antenna 920 that runs along the edge of the circuit board, but with only a small amount of extra space. Antenna 920 is mounted in the notch.

Mounting the antenna in a notch has the advantage that the notch and the antenna can be shaped to allow only a narrow range of positions for mounting. This makes it easier to mount the antenna in a designated position where the protruding portions can establish desired electrical contacts with circuitry or traces on the circuit board.

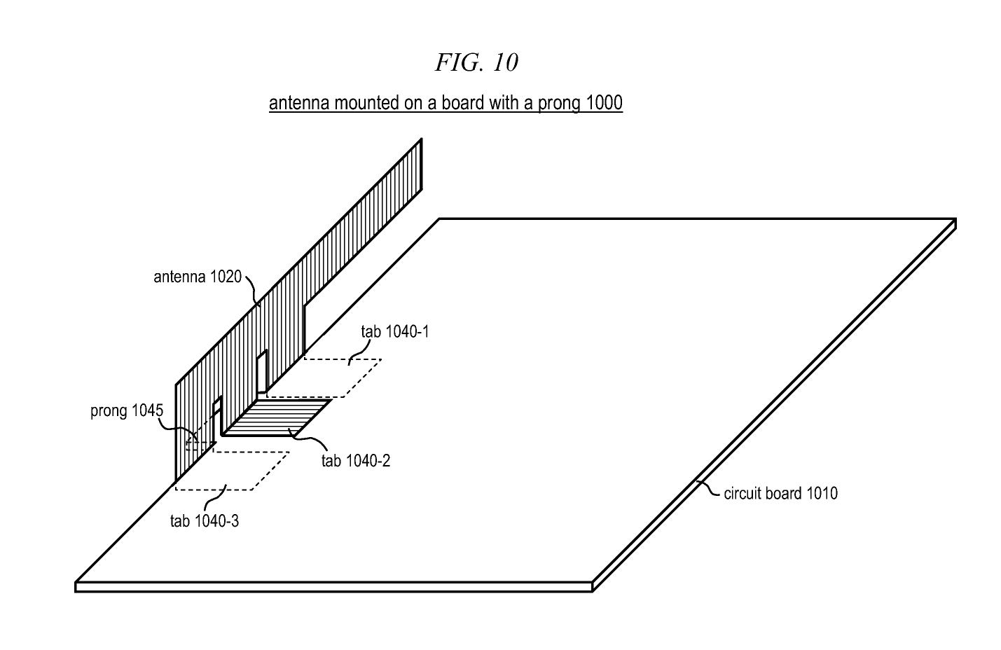

It will be clear to those skilled in the art, after reading this disclosure, that the functionality of a notch to allow only a narrow range of positions for mounting the antenna can also be achieved by a prong. In particular, the word “prong” refers to a protrusion in the shape of the circuit board wherein an edge of the circuit board has extra material that protrudes outward from the perimeter of the circuit board, compared to a straight edge. The antenna can be shaped to have a space that accommodates the prong such that, when mounted on the edge of the circuit board, the prong fits in the space, thus limiting possible positions for mounting the antenna to a narrow range. FIG. 10 depicts an illustrative embodiment of the present invention wherein the circuit board has a prong.

Although FIG. 9 depicts a single notch having a rectangular shape, it will be clear to those skilled in the art, after reading this disclosure, how to make and use embodiments of the present invention wherein one or more notches, possibly in combination with one or more prongs, are used to achieve a desired limitation of possible positions for mounting the antenna, and wherein some notches or prongs have shapes other than rectangular.

Although FIG. 9 depicts an antenna with a specific shape, it will be clear to those skilled in the art, after reading this disclosure, how to make and use embodiments of the present invention wherein the antenna is made differently, with any number of protruding portions, with or without protuberances or sharp edges, or with other variations.

FIG. 10 depicts an antenna for mounting on an edge of a circuit board in accordance with an alternative illustrative embodiment of the present invention. The circuit board is depicted by circuit board 1010. The antenna is depicted by antenna 1020, which is a piece of sheet metal shaped to have protruding portions, one of which is depicted by tab 1040-2 in FIG. 10. The Figure depicts a perspective view. Antenna 1020 has two additional protruding portions, depicted by tabs 1040-1 and 1040-3, which protrude over the bottom side of circuit board 1010; because they protrude over the bottom side, they are not visible in FIG. 10 and, accordingly they are shown as dashed outlines. Antenna 1020 is depicted as mounted on an edge of circuit board 1010 with prong 1045 accommodated by a space in antenna 1020 between tabs 1040-1 and 1040-3.

Although FIG. 10 depicts a single prong having a rectangular shape, it will be clear to those skilled in the art, after reading this disclosure, how to make and use embodiments of the present invention wherein one or more prongs, possibly in combination with one or more notches, are used to achieve a desired limitation of possible positions for mounting the antenna, and wherein some prongs or notches have shapes other than rectangular.

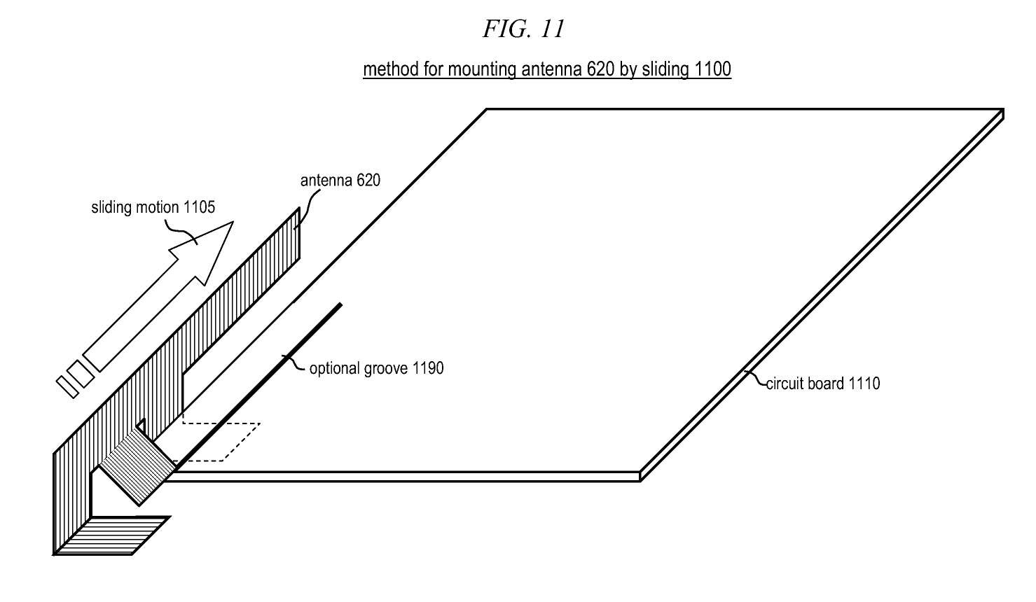

FIG. 11 depicts a method for mounting an antenna to be mounted on an edge of a circuit board in accordance with an alternative illustrative embodiment of the present invention. The circuit board is depicted by circuit board 1110. The antenna is depicted by antenna 620. The Figure depicts a perspective view.

FIG. 11 depicts sliding motion 1105 whereby antenna 620 can be mounted on an edge of circuit board 1110 by sliding it into a desired position along a direction parallel to the edge, as shown by the arrow with a broken tail that depicts sliding motion 1105.

Circuit board 1110 can optionally have optional groove 1190, which is a groove carved into the surface of the board in a position where it acts as a guide for sliding the antenna into position.

Although not explicitly shown in FIG. 11, it will be clear to those skilled in the art, after reading this disclosure, how to make and use embodiments of the present invention wherein sliding motion 1105 is used to mount antennas made or mounted in accordance with other embodiments of the present invention such as, for example and without limitation, the embodiments illustrated in conjunction with FIGS. 4 through 9.

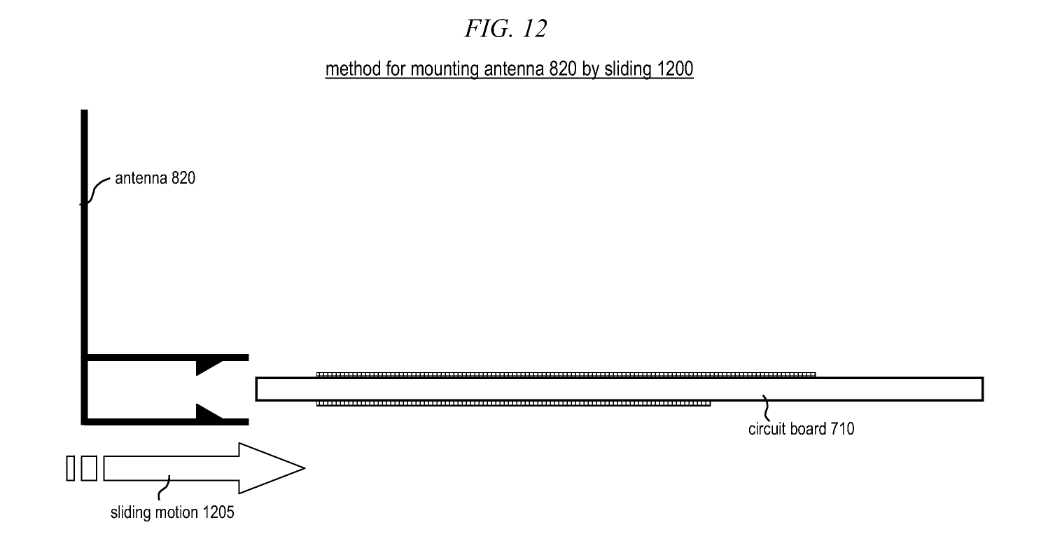

FIG. 12 depicts a method for mounting an antenna to be mounted on an edge of a circuit board in accordance with an alternative illustrative embodiment of the present invention. The circuit board is depicted by circuit board 710. The antenna is depicted by antenna 820. The Figure depicts an edge view.

FIG. 12 depicts sliding motion 1205 whereby antenna 820 can be mounted on an edge of circuit board 710 by sliding it into a desired position along a direction orthogonal to the edge, as shown by the arrow with a broken tail that depicts sliding motion 1205.

Circuit board 710 can optionally have grooves carved into the board in a position to act as guides for sliding the antenna into position.

Although not explicitly shown in FIG. 12, it will be clear to those skilled in the art, after reading this disclosure, how to make and use embodiments of the present invention wherein sliding motion 1205 is used to mount antennas made or mounted in accordance with other embodiments of the present invention such as, for example and without limitation, the embodiments illustrated in conjunction with FIGS. 4 through 9.

Although FIGS. 11 and 12 depict, respectively, a sliding motion parallel to an edge of circuit board 1110, and a sliding motion orthogonal to an edge of circuit board 710, it will be clear to those skilled in the art, after reading this disclosure, how to make and use embodiments of the present invention wherein an antenna is mounted on an edge of a circuit board with a sliding motion in a different direction such as, for example and without limitation, in an oblique direction, or with another type of sliding motion.

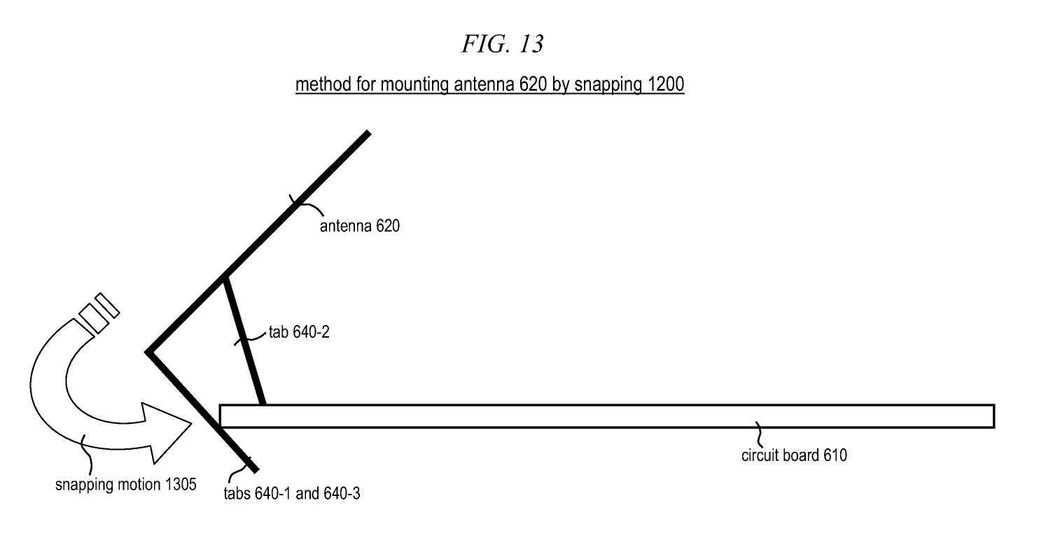

FIG. 13 depicts a method for mounting an antenna to be mounted on an edge of a circuit board in accordance with an alternative illustrative embodiment of the present invention. The circuit board is depicted by circuit board 610. The antenna is depicted by antenna 620. The Figure depicts an edge view.

FIG. 13 depicts snapping motion 1305 whereby antenna 620 can be mounted on an edge of circuit board 610 by snapping it into a desired position, as shown by the arrow with a broken tail that depicts snapping motion 1305. Snapping motion 1305 engages tabs 640-1, 640-2, and 640-3 such that the springiness of tab 640-2 is activated. The word “activated” means that tab 640-2 is pushed away from its relaxed position into a position where its springiness makes it push back toward its relaxed position. As snapping motion 1305 proceeds, the springiness of tab 640-2 is activated such that, after completion of the snapping motion, antenna 620 is in a desired position, with the springiness of tab 640-2 applying a desired pressure on a desired spot on circuit board 610.

Circuit board 610 can optionally have grooves or other indentations carved into the board in a position to act as guides for snapping the antenna into position.

Although FIG. 13 depicts snapping motion 1305 as a circular twisting motion, it will be clear to those skilled in the art, after reading this disclosure, how to make and use embodiments of the present invention wherein a different snapping motion, or a combination of one or more snapping or sliding motions, are used to mount an antenna on an edge of a circuit board.

Although not explicitly shown in FIG. 13, it will be clear to those skilled in the art, after reading this disclosure, how to make and use embodiments of the present invention wherein a snapping motion is used to mount antennas made or mounted in accordance with other embodiments of the present invention such as, for example and without limitation, the embodiments illustrated in conjunction with FIGS. 6a through 9.

It is to be understood that this disclosure teaches just some examples of illustrative embodiments and that many variations of the present invention can easily be devised by those skilled in the art, after reading this disclosure, and that the scope of the present invention is to be determined by the following claims.

What is claimed is:

1. An antenna comprising:
a piece of electrically conductive material having two or more protruding portions;
wherein the protruding portions are shaped such that the antenna can be mounted on an edge of a circuit board, with a first one of the protruding portions extending in a boardward direction over a first side of the circuit board, and a second one of the protruding portions extending in a boardward direction over a second side of the circuit board; and
wherein the first side and the second side are opposite sides.

2. The antenna of claim 1 wherein the piece of electrically conductive material is made of metal.

3. The antenna of claim 2 wherein the piece of electrically conductive material is made of sheet metal.

4. The antenna of claim 1
wherein at least one of the protruding portions has springiness; and
wherein the springiness holds the antenna affixed to the circuit board, when mounted on the edge of the circuit board.

5. The antenna of claim 1
wherein at least one of the protruding portions has springiness; and
wherein the springiness causes one of the protruding portions to apply pressure to a trace on the circuit board; and
wherein the pressure is of sufficient strength to cause the one of the protruding portions that applies pressure to establish a reliable electrical contact with the trace.

6. The antenna of claim 5 wherein the one of the protruding portions that is caused to apply pressure has a protuberance that facilitates the reliable electrical contact.

7. The antenna of claim 6 wherein the protuberance comprises a sharp edge.

8. The antenna of claim 1 wherein the first protruding portion comprises a first anchor point for an electrical connection between the antenna and a first trace on the first side of the circuit board.

9. The antenna of claim 8 wherein the second protruding portion comprises a second anchor point an electrical connection between the antenna and a second trace on the second side of the circuit board.

10. The antenna of claim 1 wherein a portion of the antenna is shaped such that it fits in a notch in the circuit board.

11. The antenna of claim 1 wherein a portion of the antenna is shaped such that it accommodates a prong in the circuit board.

12. An apparatus comprising:
a circuit board,
a first electronic circuit for wireless communication mounted on a first side of the circuit board, and
an antenna;
wherein the antenna comprises a piece of electrically conductive material having two or more protruding portions;
wherein the antenna is mounted on an edge of the circuit board, with at least a first one of the protruding portions extending in a boardward direction over the first side of the circuit board, and at least a second one of the protruding portions extending in a boardward direction over a second side of the circuit board;
wherein the first side and the second side are opposite sides; and
wherein the first protruding portion is electrically connected to the first electronic circuit.

13. The apparatus of claim 12 further comprising:
a second electronic circuit for wireless communication mounted on the second side of the circuit board;
wherein second protruding portion is electrically connected to the second electronic circuit; and
wherein the first electronic circuit and the second electronic circuit are mutually interconnected electrically.

14. The apparatus of claim 13 wherein the second electronic circuit is a ground plane.

15. The apparatus of claim 12
wherein at least one of the protruding portions has springiness, and
wherein the springiness holds the antenna affixed to the circuit board on the edge of the circuit board.

16. The apparatus of claim 15
wherein the springiness also causes one of the protruding portions to apply pressure to a trace on the circuit board; and
wherein the pressure is of sufficient strength to cause the one of the protruding portions that applies pressure to establish a reliable electrical contact with the trace.

17. The apparatus of claim 16 wherein the one of the protruding portions that is caused to apply pressure has a protuberance that facilitates the reliable electrical contact.

18. The apparatus of claim 17 wherein the protuberance comprises a sharp edge.

19. The apparatus of claim 12 further comprising:
a notch in the circuit board;
wherein the antenna has a portion shaped such that it fits in the notch in the circuit board.

20. The apparatus of claim 12 further comprising:
a prong in the circuit board;
wherein the antenna has a portion shaped such that it accommodates the prong in the circuit board.

21. A method for making an antenna, the method comprising:
shaping a piece of electrically conductive material such that the shaped piece has two or more protruding portions, and
shaping the piece of electrically conductive material such that the shaped piece has electromagnetic properties suitable for using as part of an antenna;
wherein the protruding portions are shaped such that the shaped piece can be mounted on an edge of a circuit board, with a first one of the protruding portions extending in a boardward direction over a first side of the circuit board, and a second one of the protruding portions extending in a boardward direction over a second side of the circuit board; and
wherein the first side and the second side are opposite sides.

22. The method of claim 21 wherein the piece of electrically conductive material is made of metal.

23. The method of claim 22 wherein the piece of electrically conductive material is made of sheet metal.

24. The method of claim 21 wherein
the electrically conductive material is capable of providing springiness, and
at least one of the protruding portions is made to have springiness such that the springiness holds the antenna affixed to the circuit board, when mounted on the edge of the circuit board.

25. The method of claim 24
wherein the springiness also causes one of the protruding portions to apply pressure to a trace on the circuit board; and
wherein the pressure is of sufficient strength to cause the one of the protruding portions that applies pressure to establish a reliable electrical contact with the trace.

26. The method of claim 25 wherein the one of the protruding portions that is caused to apply pressure is shaped to have a protuberance that facilitates the reliable electrical contact.

27. The method of claim 26 wherein the protuberance comprises a sharp edge.

28. The method of claim 21 wherein a portion of the antenna is shaped such that it fits in a notch in the circuit board.

29. The method of claim 21 wherein a portion of the antenna is shaped such that it accommodates a prong in the circuit board.

30. A method for mounting an antenna on an edge of a circuit board, the method comprising:
procuring an antenna that comprises a piece of electrically conductive material having two or more protruding portions;
affixing the antenna on the edge of the circuit board such that a first one of the protruding portions extending in a boardward direction over a first side of the circuit board, and a second one of the protruding portions extending in a boardward direction over a second side of the circuit board;
wherein the first side and the second side are opposite sides.

31. The method of claim 30 wherein affixing comprises sliding the antenna onto the edge of the circuit board.

32. The method of claim 30
wherein at least one of the protruding portions has springiness; and
wherein the springiness holds the antenna affixed to the circuit board, when mounted on the edge of the circuit board.

33. The method of claim 32 wherein affixing comprises snapping the antenna onto the edge of the circuit board such that the springiness is activated.

34. The method of claim 33
wherein the springiness also causes one of the protruding portions to apply pressure to a trace on the circuit board; and
wherein the pressure is of sufficient strength to cause the one of the protruding portions that applies pressure to establish a reliable electrical contact with the trace.

35. The method of claim 34 wherein the snapping enhances the pressure and enhances the reliability of the electrical contact.

36. The method of claim 32 wherein affixing comprises placing a portion of the antenna in a notch in the circuit board.

37. The method of claim 32 wherein affixing comprises placing a prong in the circuit board in a portion of the antenna.
